(19) United States
(12) Patent Application Publication
(10) Pub. No.: US 2008/0235369 A1
(43) Pub. Date: Sep. 25, 2008

(54) Distributing replication assignments among nodes

(76) Inventors: Rita H. Wouhaybi, Hillsboro, OR (US); Mic Bowman, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/726,189

(22) Filed: Mar. 21, 2007

(51) Int. Cl. G06F 15/173

(52) U.S. Cl. 709/224

(57) ABSTRACT

Replication in distributed systems may be based on a determination of the number of connections to a node to be replicated. When a new user is adding a node in a distributed system, the number of connections between nodes connected to the new node is determined. In addition, the change in relationships among nodes directly influence the changes in their respective connections. A ranking based on the number of connections is developed and data associated with a node is replicated based on its ranking.

### BACKGROUND

This relates generally to distributed computing and, particularly, to replication in distributed systems.

Distributed computing involves having different parts of a software program run simultaneously on two or more computers that communicate over a network. Examples of distributed computing include the Internet, client-server architecture, and peer-to-peer architecture. In a client-server architecture, the client contacts the server for data and then operates on that data. In a peer-to-peer architecture, all of the machines are equal in the hierarchy and they may communicate amongst one another. A distributed computing system may include multiple processors or multiple cores. It may also include computer clusters of multiple stand alone machines acting in parallel over high speed networks.

Replication is the use of redundant resources to improve performance. The resources may be software or hardware components. Replication in space involves storing the same data on multiple storage devices or executing the same computing tasks on multiple devices. Replication in time involves executing a computing task repeatedly on a single device.

A distributed system may be considered as a collection of nodes. The nodes may, in effect, be different users or different hardware systems that communicate with one another. The participating nodes in a distributed system replicate data to ensure its availability when a node that offered the data leaves the network.

### BRIEF DESCRIPTION OF THE DRAWINGS

FIG. 1 shows a ranking system according to one embodiment;

FIG. 2 is a network topology in accordance with one embodiment of the present invention; and

FIG. 3 is a flow chart for a sequence in accordance with one embodiment.

### DETAILED DESCRIPTION

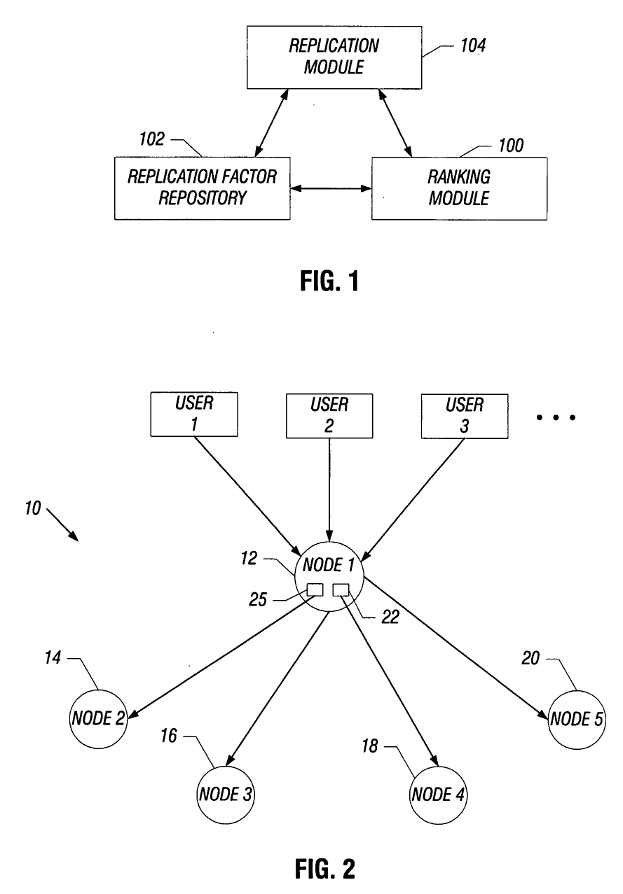

In distributed networks established through user interaction, the resulting connectivity can often be predictable because it follows human communications. This connectivity often reflects the importance of a specific node because some nodes may become important to the well being of the entire network. In order to maintain network availability, it is desirable to replicate important nodes. Node replication may be the replication of the node itself or data associated with the node. In order to intelligently replicate data, replication may be implemented according to a ranking system and may use a replication module 104, as well as a repository 102 of ranking weights, as shown in FIG. 1.

A ranking module 100 determines how important a node is to the entire network and to its surrounding nodes based on its degree or number of nodes connected to it. This ranking may change over time based on the operation of the system by different users. The result of the ranking module 100 is a ranking weight associated with a respective node. That ranking weight may be stored at a replication factor repository 102. The replication factor repository 102 can be distributed or centralized, depending on the nature of the network itself. The replication module 104 reads the ranking weight of a node from the replication factor repository, determines the replication factor including how many times the data should be replicated, and on which nodes, and sends control messages to the concerned nodes.

Thus, referring to FIG. 2, a distributed computing network 10 may include a plurality of nodes 12, 14, 16, 18, and 20. The node 12 may communicate with the other nodes, as indicated by the arrows. One or more users may communicate with the node 12, as also indicated. The node 12 may include software 22 for implementing intelligent replication and may include, in one embodiment, the replication module 104, replication factor repository 102, and ranking module 100.

Thus, in one embodiment, a node or its data may be replicated by first reading the rank of the node. The rank of the node may be normalized so that the normalized rank is dependent on the size of the network that the ranking module 100 recognizes. Next, the actual set of nodes that will receive data is determined. Then, the replication may be performed by determining the number of times that the data should be replicated and the nodes on which it should be replicated.

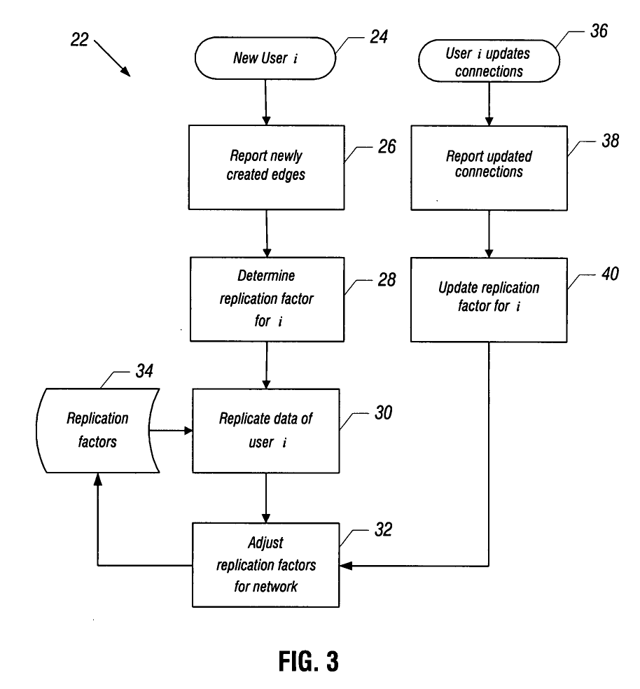

Referring to FIG. 3, the software 22 for replication initially determines when there is a new user i, as indicated in block 24. Any newly created edges are reported, as indicated in block 26. A newly created edge is an association or connection that is created for a new user with an existing user. The replication factor is then determined, as described above and as indicated in block 28. The data for the user i is then replicated, as indicated in block 30. The replication may be adjusted based on the replication factors for the network in block 32. The replication factors 34 may then be applied.

As the user updates connections, as indicated in block 36, the updated connections may be reported in block 38, and the replication factor for the user i may be updated, as indicated in block 40.

By taking in consideration the importance of a user or node to the network, the replication of data may be implemented in a more intelligent fashion. Systems that replicate data with uniform frequency, do not take into consideration the inherent characteristics of a network. Networks are formed by people who tend to follow trends with well defined and known characteristics. By replicating nodes based on degree or number of nodes connected to a given node, and by updating with new users and connections, a more intelligent replication system may be implemented.

An embodiment may be implemented by hardware, software, firmware, microcode, or any combination thereof. When implemented in software, firmware, or microcode, the elements of an embodiment are the program code or code segments to perform the necessary tasks. The code may be the actual code that carries out the operations, or code that emulates or simulates the operations. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor/machine readable/accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The term “data” here refers to any type of information that is encoded for machine-readable purposes. Therefore, it may include program, code, data, file, etc.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions: to enable a computer to:
determine when a new user is using a node in a distributed system;
in response to the detection of the new user, determine the number of connections to the node used by the user;
develop a ranking based on the number of connections; and
replicate data associated with the node based on its ranking.

2. The medium of claim 1 further including instructions to record newly created edges.

3. The medium of claim 2 further including instructions to determine a replication factor based on the number of connections.

4. The medium of claim 3 further including instructions to periodically update said replication factor.

5. The medium of claim 4 further including instructions to store said ranking in a replication repository.

6. A computer system comprising:
a plurality of nodes coupled to one another; and
at least one of said nodes including a replication repository to store a ranking and a replication module to develop the ranking based on the number of connections among nodes.

7. The system of claim 6 wherein said system to determine when a new user is adding a node to the distributed system.

8. The system of claim 7 wherein said ranking module to record newly recorded edges.

9. The system of claim 8 wherein said ranking module to periodically update said ranking.

10. The system of claim 6 wherein said replication repository is coupled to said ranking module to automatically store said replication ranking in said replication repository.
